(19) United States
(12) Patent Application Publication
(10) Pub. No.: US 2026/0277898 A1
(43) Pub. Date: Sep. 17, 2026

(54) MULTI-AGENT REAL-TIME RESEARCH SYSTEM AND METHOD

(71) Applicant: Vorys, Sater, Seymour and Pease, LLP, Columbus, OH (US)

(72) Inventors: Nathan Duane JEDINAK, Upper Arlington, OH (US); Sruthi DEVARACHETTY, Scottsdale, AZ (US)

(73) Assignee: Vorys, Sater, Seymour and Pease, LLP, Columbus, OH (US)

(21) Appl. No.: 19/566,361

(22) Filed: Mar. 13, 2026

Related U.S. Application Data
(63) Continuation-in-part of application No. 19/080,378, filed on Mar. 14, 2025.

(51) Int. Cl. G06F 16/2453; G06F 16/2457; G06Q 50/18

(52) U.S. Cl. CPC G06F 16/24542; G06F 16/24578; G06Q 50/18

(57) ABSTRACT

System and method for providing real-time research in response to a user query. A multi-agent service platform communicates with user devices over a network. A multi-agent layer has agents responsible for issue identification, planning, real-time search, ranking, analysis, and rule application. An orchestration layer manages communication between these agents, and a storage layer that manages data retrieval and storage. In one embodiment, the real-time research relates to labor and employment law.

### CROSS-REFERENCE TO RELATED APPLICATIONS

This application is a continuation-in-part that claims priority to and the benefit of U.S. Patent Application No. 19/080,378, titled “MULTI-AGENT REAL-TIME RESEARCH SYSTEM AND METHOD,” filed Mar. 14, 2025, in the United States Patent and Trademark Office. Each above-referenced patent application is incorporated herein by reference in its entirety.

### TECHNICAL FIELD

The technical field relates to online research and query response.

### BACKGROUND

Online search engines have been used to provide responses to user queries. A user at a remote device uses a web application to input a query. The query is sent over a network to a search engine. The search engine processes the query to obtain search results or hits. The search engine then returns a list of the search results to fulfill the query. The user can browse the list and select one or more search results to obtain further information. Snippets or portions of content associated with a search result can also be displayed to provide the user with further context.

This approach has a number of limitations. First, using conventional online search engines can be burdensome and time consuming. A user must browse a number of search results to find meaningful information which can be hard to find and spread across multiple sites. As such a user must investigate a number of hits to find relevant information which increases the demands on user time and resources and is impractical for many subject areas where a user may not be a domain expert. A user may also have to formulate multiple queries to improve the quality and relevancy of the returned hits but this too increases the work and experience required of a user.

Search engines now can provide suggestions to a user but this only helps a user to refine a query input to a search engine. The suggestions can consist of a similar string of keywords for which the user still must select. An artificial intelligence (AI) chat agent has been used to facilitate generation of suggestions for the user. Regardless, generating conventional suggestions with or without an AI chat agent for an online search query still has the technical problem of requiring numerous hits to be reviewed and selected at a user-interface before meaningful information can be accessed. The excessive work and inefficiency required in browsing returned search results is especially prohibitive when users must review complex subject matter areas. This can lead to many queries and responses having to be sent and returned over a network including network communications between a mobile device and online search engine to fulfill search requests that may not be relevant.

Generative AI (Gen AI) tools have now been introduced which allow a user to query a remote Gen AI tool, such as, an Open AI ChatGPT tool, to generate content. A user may enter a query (or prompt) into the Gen AI tool and receive generated content, such as, narrative text, images, or code, depending on the particular tool used. For online research, these Gen AI tools still have many of the drawbacks of conventional online search engines because they require a user to formulate a query and generate content that still requires a user to review and reformulate queries (prompt engineering) before relevant content is obtained. This is especially difficult when conventional GenAI tools are called upon to fulfill queries involving a domain where users may not have sufficient skill or prompt engineering expertise. Also training data for general purpose GenAI tools can lag and be out of date making them further unable to perform effective real-time search in time sensitive areas.

### BRIEF SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present aspects of the disclosure in a simplified form prior to the more detailed description that is presented hereinafter.

Methods and systems for providing online research with the support of multiple AI agents are disclosed. In one embodiment, a system for providing real-time research in response to a user query, includes a multi-agent service platform, implemented on at least one processor and configured to communicate with one or more user devices over a network. The multi-agent service platform includes an orchestration layer and a multi-agent layer. The multi-agent layer has an issue agent, planner agent, real-time search agent, ranker search agent, analysis agent and rule agent. The orchestration layer is configured to orchestrate communication between the issue agent, planner agent, real-time search agent, ranker search agent, analysis agent and rule agent. In a further embodiment, the multi-agent service platform includes a storage layer configured to manage data retrieval and storage to and from a database.

In another embodiment, a computer-implemented method for real-time research with multiple agents on an agentic AI platform is disclosed. The method includes steps of orchestrating communication between an issue agent, planner agent, real-time search agent, ranker search agent, analysis agent and rule agent implemented on at least one processor, and generating a prompt with an issue agent in response to a user query. The method includes creating an electronic research plan with a planner agent, the electronic research plan including research path information, resource locators and keyword sets, and performing searches over a network in real-time with a real-time search agent according to the electronic research plan and the generated prompt to obtain search results. Further steps are ranking the obtained search results with a ranker search agent to generate a list of data chunks and scores representative of the relevancy of keywords and the generated prompt, generating at least one electronic research memorandum with an analysis agent based on top ranked data chunks and scores in the generated list and the research path information, and analyzing each generated electronic research memorandum based on the generated prompt and context to obtain a final answer for response to the user query.

In further embodiments, systems and methods for performing real-time research relate to labor and employment law.

Any combinations of the various aspects and implementations disclosed herein can be used in a further aspect, consistent with the disclosure. These and other aspects and features can be appreciated from the following description of certain aspects presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIG. 1 is a diagram of a system for providing real-time research in accordance with one embodiment.

FIG. 2 illustrates a multi-agent service platform of FIG. 1 in further detail in accordance with one embodiment.

FIG. 3 illustrates a multi-agent layer of a tool in FIG. 2 in accordance with one embodiment.

FIG. 4 illustrates a computer-implemented method for performing real-time research in accordance with one embodiment.

FIG. 5 illustrates communication between layers in a tool in accordance with one embodiment.

FIG. 6 illustrates issue identification by an issue agent in accordance with one embodiment.

FIG. 7 illustrates electronic research plan creation by a planner agent in accordance with one embodiment.

FIG. 8 illustrates real-time search operation by a real-time search agent in accordance with one embodiment.

FIG. 9 illustrates ranked search operation by a ranked search agent in accordance with one embodiment.

FIG. 10 illustrates analysis operation performed by an analysis agent in accordance with one embodiment.

FIG. 11 illustrates rule application by a rule agent in accordance with one embodiment.

FIGS. 12A-12E illustrate example user-interface display panels having content obtained during real-time research in accordance with one embodiment.

FIG. 13 illustrates a machine learning engine implemented on a computing device in accordance with one embodiment.

### DETAILED DESCRIPTION

Embodiments in accordance with the present disclosure generally relate to computer-implemented real-time research and query response, and more particularly to systems and methods for coordinating multiple autonomous agents in an agentic artificial intelligence platform to perform network-based research and generate responses based on task- and domain-specific configurations.

Existing approaches to AI-assisted research workflows often rely on ad hoc combinations of single large language model calls, one-off prompts, or manual use of search engines or APIs. Each new question can involve re-crafting prompts, re-issuing similar searches, and recomputing rankings and analyses from scratch, with little reuse of intermediate artifacts or configuration. This can lead to duplicated work that increases CPU and accelerator utilization, repeated network calls to external services that raise bandwidth and latency demands, and storage of loosely related outputs that are difficult to reuse or keep synchronized when research paths or underlying resources change.

The systems and methods provided herein address these issues by introducing a structured, multi-agent processing pipeline built around an orchestration layer and a storage layer that manages shared configuration and intermediate artifacts. A multi-agent layer includes an issue agent, planner agent, real-time search agent, ranker search agent, analysis agent, and rule agent, each operating under control of the orchestration layer and using configuration information maintained in the storage layer. The issue agent reformulates user queries into normalized prompts, the planner agent generates structured research plans, the real-time search and ranker agents obtain and rank content, and the analysis and rule agents generate memoranda and final answers, all using parameter collections that tune model selection, prompts, and operational settings for particular tasks and domains.

By treating the outputs of earlier agents, such as final prompts, research plans, ranked chunks, and memoranda, as structured artifacts stored in the storage layer and keyed to a research session, later agents can read and extend these artifacts instead of regenerating them. The result is reduced processing overhead when a query is refined or repeated, reduced storage of redundant data across sessions, and a more predictable and maintainable workflow. A use of explicit session state and configuration records may also ensure that different views of the research process, such as answer dialogs, supporting research sections, and performance metrics, remain synchronized without additional reconciliation logic.

The technical improvements provided herein are tied to specific structural elements that optimize how a computer system processes research tasks. First, the system forms a multi-agent layer under an orchestration layer that explicitly sequences and coordinates the issue, planner, real-time search, ranker, analysis, and rule agents, so that each agent operates on well-defined inputs and outputs rather than on ad hoc prompts and results. Second, the system organizes configuration information into parameter collections stored in the storage layer, where each parameter collection specifies model selection, customized prompts, and configuration parameters for a particular task and domain (e.g., legal domain), and the orchestration layer retrieves and applies these collections per agent task. Because these parameter collections and intermediate artifacts are the canonical sources for agent behavior and for downstream outputs, the system can execute complex research workflows, reuse intermediate results across related queries, and adjust behavior by updating configuration records rather than by recomputing or duplicating heavy processing. In combination, these claimed features improve the functioning of the computer system by reducing repeated large-model invocations and search operations, lowering the volume of intermediate data that must be stored and reprocessed, and simplifying coordination between different processing stages and output views, thereby enabling more efficient and scalable handling of large numbers of research sessions.

Methods and systems for providing online research with the support of multiple AI agents are disclosed. A tool having an agentic artificial intelligence (AI) design and workflow is provided to perform high quality research in particular areas of law and provide answers to users in real-time. The tool provides users with quality answers to queries relating to law and generates answers in real-time using multiple agents including generative AI and real-time search. Multiple autonomous agents are designed with a workflow that divides tasks according to a research strategy (e.g., legal research strategy) designed to identify an issue, create a plan, perform real-time search, rank search, perform analysis (e.g., legal analysis), and apply a rule. In this way, a quality answer may be obtained for a complex research task, such as legal research, while providing users with an easy to use chat interface and minimizing demands on users for sophisticated query reformulation or prompt engineering.

Embodiments and aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the aspects disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

The term “resource locator” refers to an identifier that enables electronic access to or retrieval of digital data, such as, webpages, files, records or other content. A resource locator may identify a location on a network or computer where a resource is stored. This locator may include, but is not limited to, a uniform resource locator (URL) that enables a browser to access content or resources at a web address, a memory address, a database address, an address to a vector database, or other location identifier.

The term “real-time” refers to a capability of a system or process to respond to inputs or events within a strict period of time, such as immediately or within seconds or milliseconds. In computing and information technology, real-time systems may be designed to process data and provide outputs instantaneously or almost instantaneously, ensuring minimal latency.

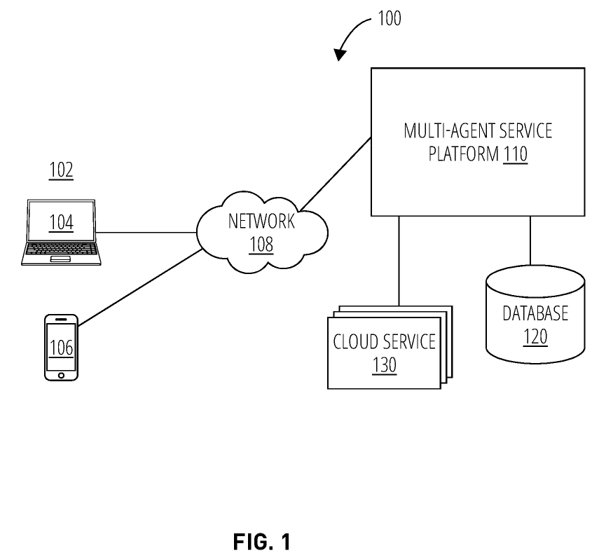

FIG. 1 is a diagram of a system 100 for providing real-time research in accordance with one embodiment. System 100 includes a multi-agent service platform 110, database 120, and one or more cloud service 130. Multi-agent service platform 110 is implemented on at least one processor and configured to communicate with one or more user devices 102 over a network 108. Multi-agent service platform 110 is also coupled to database 120 and cloud service 130.

User devices 102 may include a computer 104, mobile device 106 or any other type of computing device configured to connect over network 108 through wireless or wired communication links. Network 108 may be any type of data network or combination of data networks, such as, a local area network, medium area network, or large area network, such as the Internet. Multi-agent service platform 110 may be implemented on one or more computing devices at the same or different locations.

User device 102 may have an application and/or a browser for communicating with multi-agent service platform 110. The application can be implemented to run on user device 102 in accordance with an operating system. In another example, an application may be a web application running in a tab or page within a browser.

User device 102 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 108.

In embodiments, multi-agent service platform 110 may be part of a cloud service computing architecture having one or more servers and computer-readable memory for data storage. Database 120 stores digital data and can include a database management application. Cloud service 130 may be one or more cloud services for performing additional functions requested by multi-agent service platform 110. For example, multi-agent service platform 110 may use an application programming interface (API) to call a cloud service. Such a cloud service may be used to perform aspects of generative AI processing, machine learning, web crawling, web searching, data operations, analysis or other operations requested by multi-agent service platform 110. The operation of multi-agent service platform 110 and cloud service 130 are further described further below. Leveraging cloud service 130 in this way may allow computationally intensive operations to be moved off of user devices 102 and onto scalable backend resources, reducing local device power usage while maintaining responsive behavior.

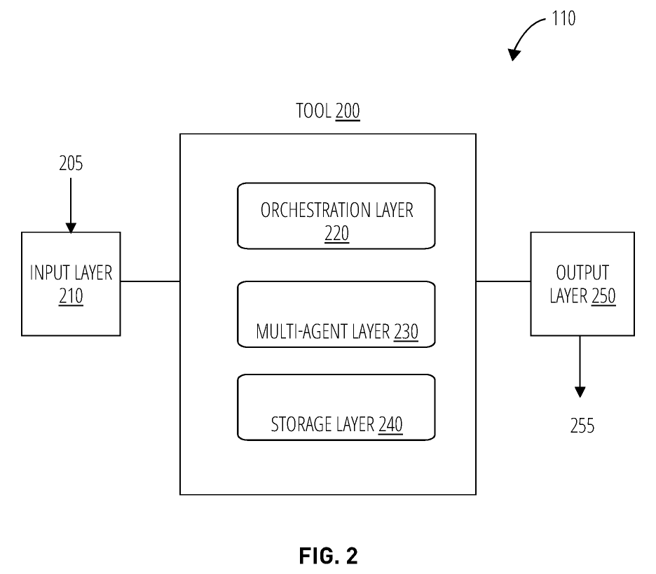

FIG. 2 illustrates multi-agent service platform 110 in further detail in accordance with an embodiment. In some embodiments, orchestration layer 220, multi agent layer 230, and storage layer 240 are deployed as distinct services or processes that communicate over well-defined interfaces, which may permit independent scaling of orchestration versus storage as query volume or corpus size grows. Decoupling these layers can enable operators to allocate additional compute or memory resources only where needed, improving overall infrastructure efficiency. As shown in FIG. 2, multi-agent service platform 110 includes a tool 200. tool 200 includes orchestration layer 220, multi-agent layer 230, and storage layer 240. This decomposition into layers provides a concrete structural framework: multi-agent layer 230 encapsulates the task-specific behavior of individual agents; orchestration layer 220 determines how and when those agents are invoked and how data flows between them; and storage layer 240 is responsible for persisting configuration information and intermediate and final research artifacts. The claimed system therefore specifies not only the presence of agents, but also their arrangement and interaction within this layered framework, which may support clearer separation of concerns in software and hardware deployment. Orchestration layer 220 orchestrates communication between agents in multi-agent layer 230. Input layer 210 and output layer 250 may also be coupled to or part of tool 200. Orchestration layer 220 may also orchestrate communication between input layer 210 and tool 200 and between output layer 250 and tool 200. Storage layer 240 manages data retrieval and storage to and from database 120. Separating these responsibilities into distinct layers may enable system operators to tune storage capacity, compute capacity, and orchestration logic independently, which can improve flexibility when deploying the system in different hardware environments.

Input data 205 is input to tool 200 through input layer 210. Input data 205 may include user queries, prompts, or other data input through user devices 102. Input data 205 may also include data retrieved or accessed from database 120 or cloud service 130 for use in tool 200. This input data may include web search results, image, text, or other content. Output data 255 may include output sent to user devices 102 in response to user queries. Output data 255 may also include output sent to database 120 or cloud service 130. Output data may include data queries sent by tool 200 to database 120 for data retrieval or storage, and may include API calls or other requests made by tool 200 to cloud service 130. In one embodiment, input layer 210 and output layer 250 each communicate with an application at a user device 102 such that a user interface panel can enable a user to enter queries and follow up responses, and to view questions, answer dialogs and a final answer output by tool 200 after research is complete.

In one embodiment, multi-agent service platform 110 is an agentic AI platform and each agent in the multi-agent layer 230 acts autonomously in response to respective communication with orchestration layer 220. This agentic behavior may reduce the need for centralized procedural logic and may allow multi-agent service platform 110 to scale across additional computing nodes without tightly coupling the behavior of individual agents.

Other technical features may be readily apparent to one skilled in the art from the following figures, descriptions, and claims.

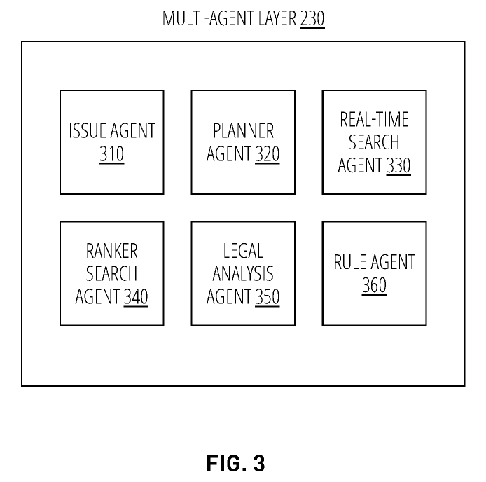

FIG. 3 illustrates multi-agent layer 230 of tool 200 in accordance with one embodiment. Multi-agent layer 230 includes an issue agent 310, planner agent 320, real-time search agent 330, ranker search agent 340, analysis agent 350 (e.g., a legal analysis agent), and rule agent 360. In one feature, orchestration layer 220 is configured to orchestrate communication between each of the agents, namely, issue agent 310, planner agent 320, real-time search agent 330, ranker search agent 340, analysis agent 350, and rule agent 360. In this way, the agents may operate autonomously and in parallel. Orchestration layer 220 may also operate a chatbot for communicating with an application or browser on user device 102. The ability of the agents to operate autonomously and in parallel under orchestration layer 220 means that different stages of the research pipeline can be overlapped where dependencies allow, such as performing search for one research path while ranking or analyzing results for another, which is enabled by the explicit separation of agent roles in multi-agent layer 230. This overlapping execution may improve throughput on multi-core or distributed computing environments. Allowing agents to run concurrently under orchestration control may increase utilization of multi-core processors or distributed nodes and may reduce the elapsed time required to complete complex research tasks.

In one embodiment, issue agent 310 generates a final prompt in response to a user query. For example, issue agent 310 can generate one or more follow up questions for the user, assess whether the query and user's responses to follow up questions contain more than one issue, and rewrite outputs in an attorney persona until the final prompt is generated and output to orchestration layer 220. Because issue agent 310 reformulates user query 602 into a final prompt 622 expressed in a normalized attorney persona, and because subsequent agents operate based on that final prompt rather than on arbitrary user phrasing, the system establishes a consistent internal representation of the research question that is used across planning, search, ranking, analysis, and rule application stages. This consistency may reduce divergence in downstream behavior and may decrease the number of iterations needed to reach an acceptable final answer. Using a consistent internal representation of the user’s question in this way may reduce the number of model calls needed to clarify the issue across later stages, which can improve both latency and resource usage.

Planner agent 320 creates an electronic research plan. The electronic research plan includes research path information, resource locators and keyword sets. The inclusion of research path information, resource locators, and keyword sets within the electronic research plan means that, at runtime, orchestration layer 220 can drive real-time search agent 330 and ranker search agent 340 using a fixed schema that is independent of the particular query text, providing a specific mechanism by which planning output governs subsequent network and ranking operations. This schema-driven approach may simplify orchestration logic and reduce branching complexity in agent implementations. In one example, planner agent 320, in communication with orchestration layer 220, can generate a list of legal research paths and identify jurisdictions based on the final prompt from issue agent 310. For each legal research path, planner agent 320 generates a number of sets of keywords and for each jurisdiction in each legal research path identifies resource locators of vetted sites to search. By generating these structured inputs in advance, the system may avoid ad hoc query construction at later stages, which can reduce processing overhead and simplify error handling.

Real-time search agent 330 performs searches over network 108 in real-time based on the electronic research plan and the final prompt to obtain search results. For example, real-time search agent 330, in communication with orchestration layer 220, may receive pairs of resource locators and sets of keywords output by planner agent 320 and perform the searches in real-time based on the received pairs of resource locators and sets of keywords to obtain the search results. Ranker search agent 340 ranks the obtained search results to generate a list of data chunks and scores representative of the relevancy of keywords and the final prompt. The generation of “a list of data chunks and scores” by ranker search agent 340 thus produces a structured intermediate representation that is used by analysis agent 350 and rule agent 360 as a compact, relevance-ordered view of the retrieved corpus, rather than requiring those agents to re-evaluate raw search results. This separation of concerns allows the more compute-intensive analysis agents to operate on a smaller, pre-filtered dataset. In one example, ranker search agent 340, in communication with orchestration layer 220, receives the legal research paths, associated keywords and search results, and the prompt, and ranks the obtained search results to generate the list of data chunks and scores representative of the relevancy of keywords and the generated prompt. Treating ranked chunks as a defined interface between retrieval and analysis may improve cache locality and reduce the amount of data that later agents must hold in memory at one time.

Finally, analysis agent 350, in communication with orchestration layer 220, generates one or more electronic research memorandum based on the top ranked data chunks and scores in the generated list and research path information. Rule agent 360 analyzes each generated electronic research memorandum based on the final prompt and context to obtain a final answer for response to the user query. For example, rule agent 360, in communication with orchestration layer 220, may receive a set of research memorandum output by analysis agent 350, context and the final prompt. Rule agent 360 analyzes each generated electronic research memorandum in the set based on the final prompt and context to obtain a final answer for response to the user query.

In this way, multi-agent service platform 110 operates with an agentic AI design to perform online research. Multiple agents in multi-agent layer 230 each carry out the research autonomously with and in communication with orchestration layer 220. The multi-agent layer 230 divides the tasks of multiple agents according to a legal research strategy designed to identify an issue > create a plan > real-time search > rank search > perform legal analysis > apply rule. By assigning distinct, specialized responsibilities to issue agent 310, planner agent 320, real-time search agent 330, ranker search agent 340, analysis agent 350, and rule agent 360, and by allowing orchestration layer 220 to coordinate their execution in a pipelined or partially parallel fashion, some embodiments may reduce idle time of compute resources and keep each agent operating on data that is most relevant to its function. This division of labor can consolidate expensive language-model processing into fewer, better-targeted calls and may shorten the overall critical path for answering complex legal queries on the same set of servers. Because the stages of “identify an issue,” “create a plan,” “real-time search,” “rank search,” “perform legal analysis,” and “apply rule” are each implemented as discrete agents with defined inputs and outputs under orchestration control, the system can measure and adjust the behavior of each stage independently by updating parameter collections and configuration information, while preserving the overall workflow. This modularity may allow individual stages to be optimized or scaled without redesigning the entire pipeline, improving maintainability and resource utilization. Additionally, organizing processing in this staged manner may allow system 100 to reuse intermediate results across related queries and may therefore reduce repeated data retrieval and analysis operations.

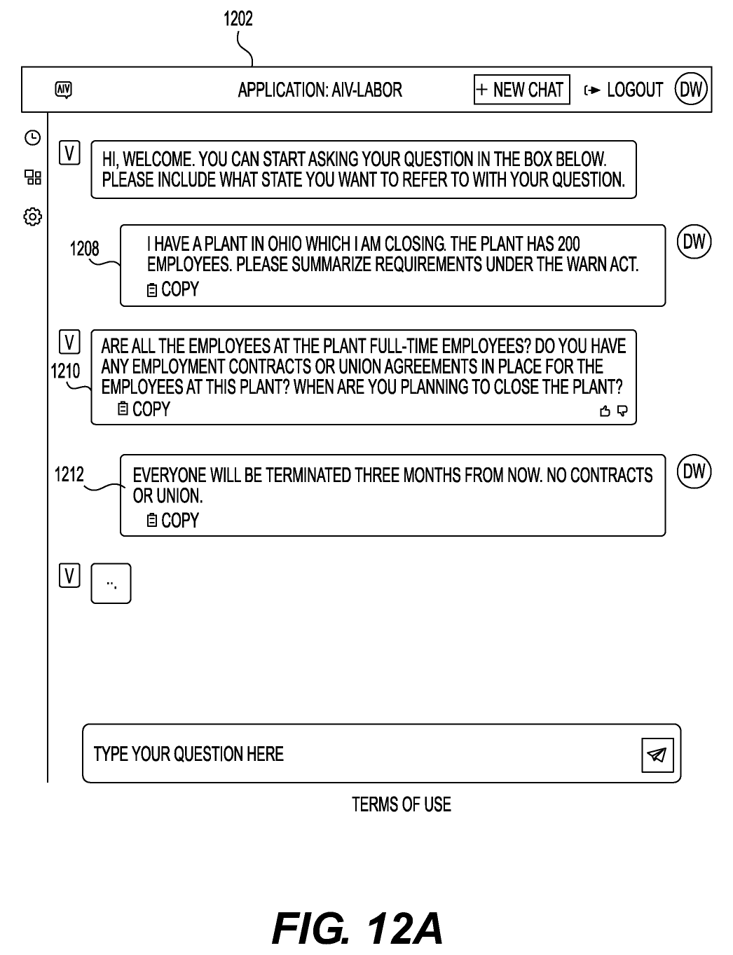

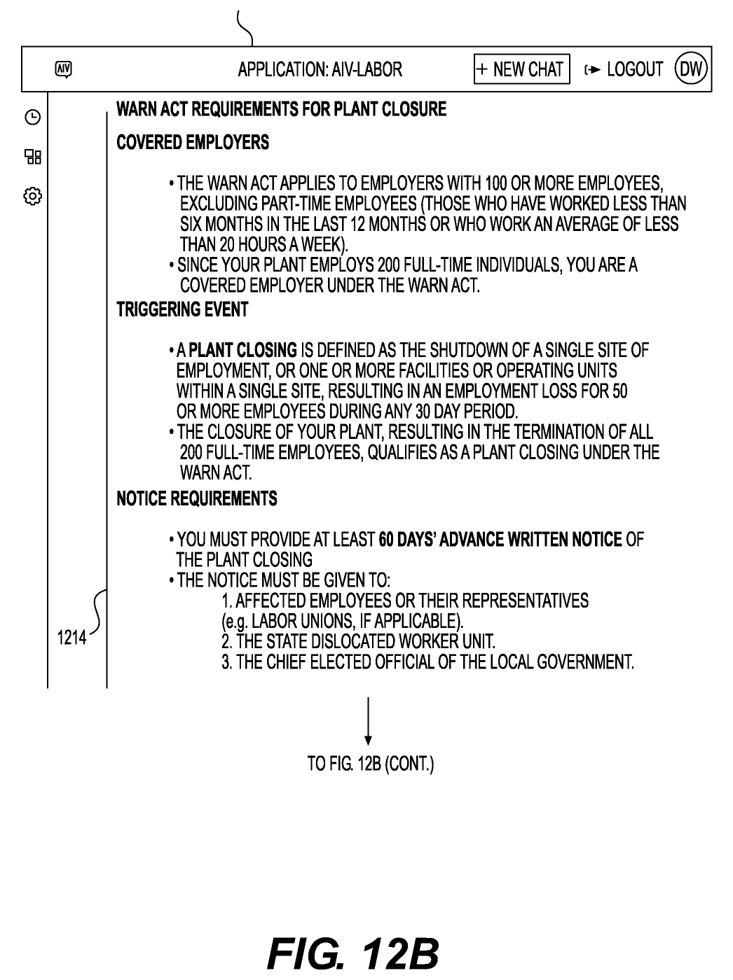

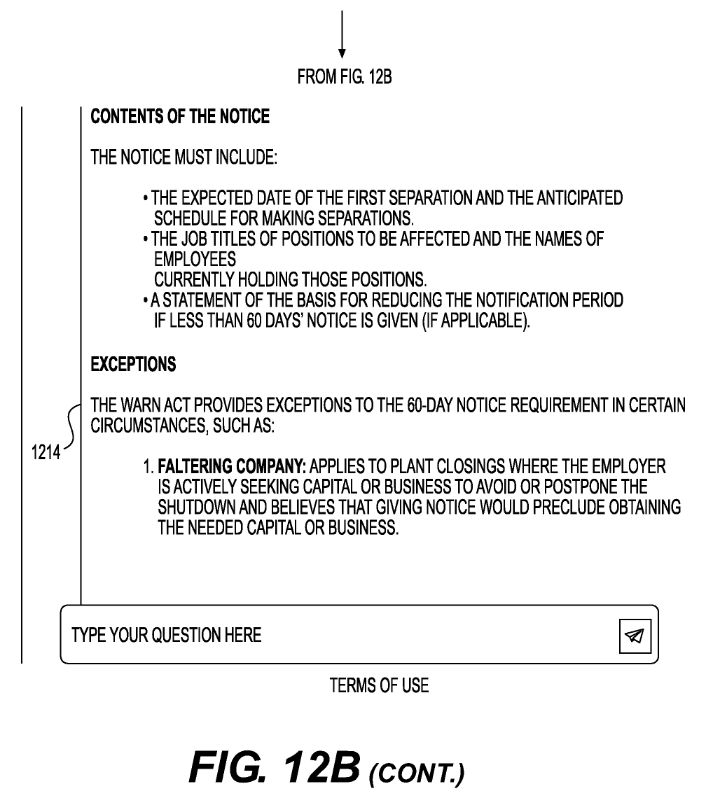

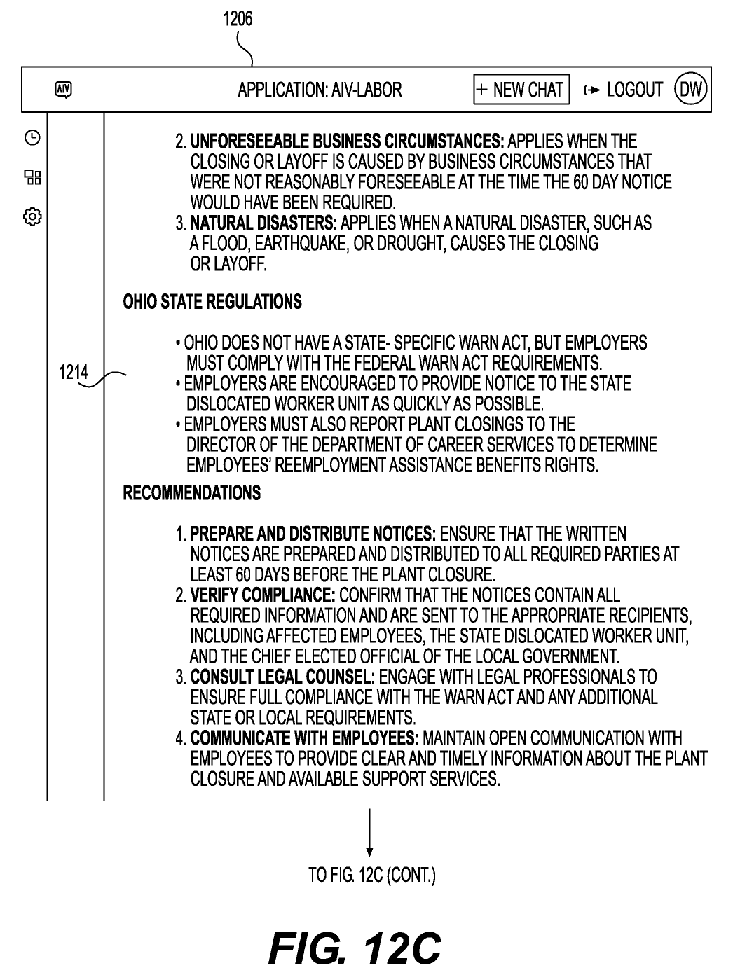

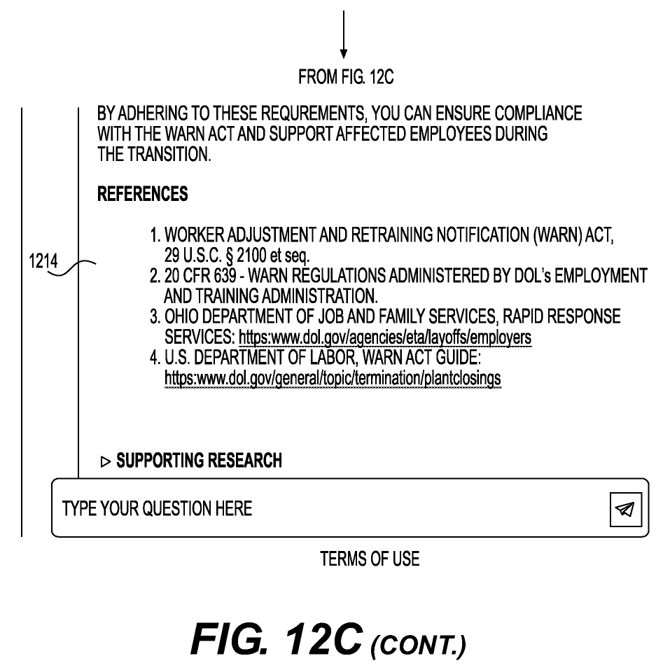

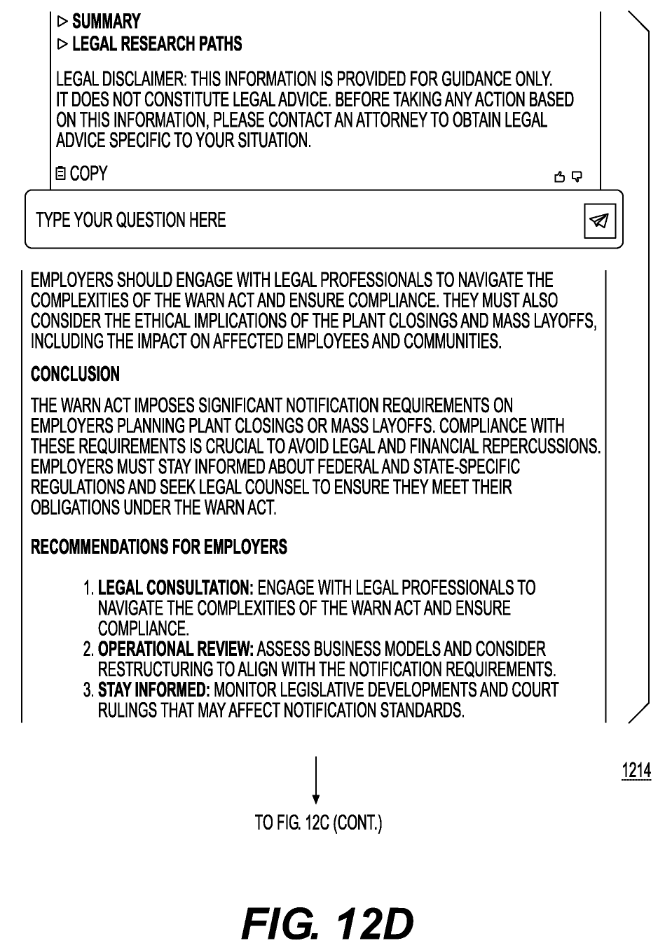

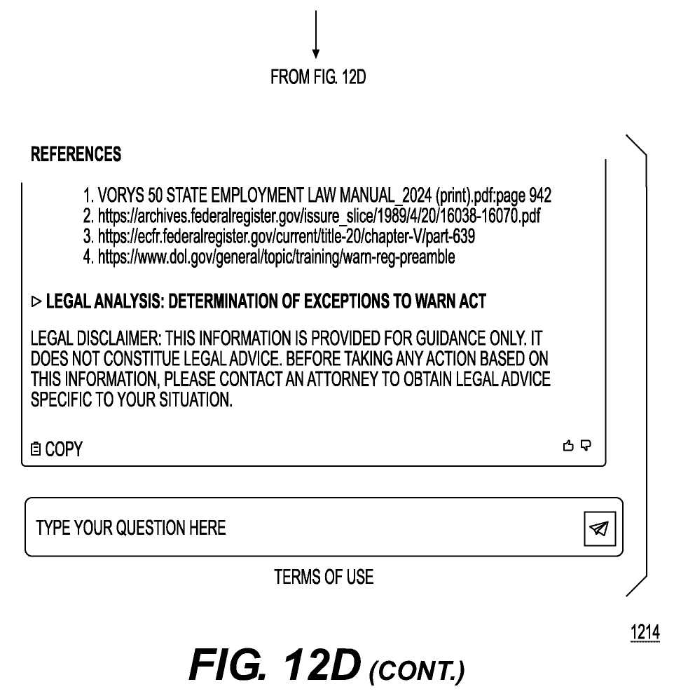

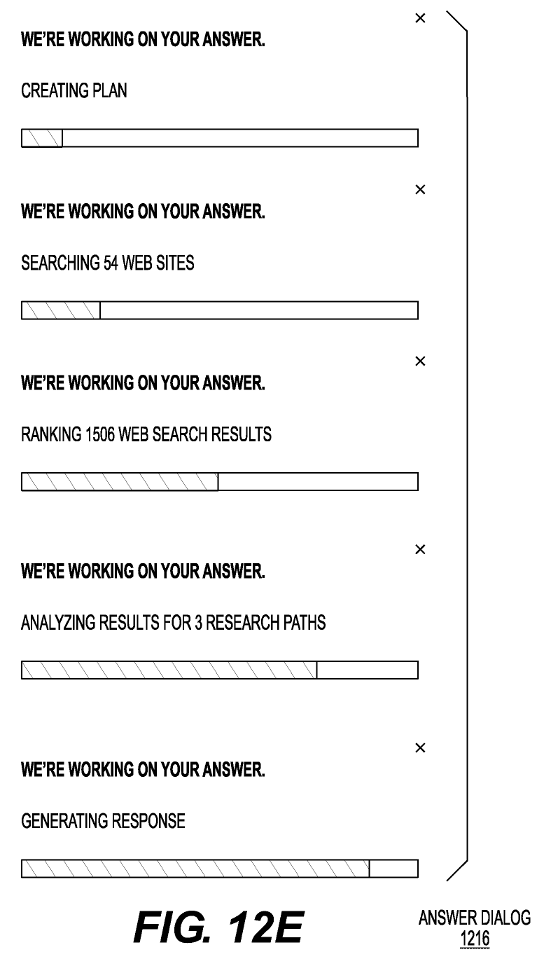

In another feature, orchestration layer 220 includes a data tracker that tracks and stores performance data as research is performed by tool 200. The performance data is indicative of the activity carried out at different stages and may include the number of resources searched (such as, the number of web sites searched), number of web search results ranked, and number of research paths being analyzed. Tool 200 then uses the performance data to generate answer dialogs as described below with respect to FIG. 12E.

In a further feature, the real-time research performed by system 100 and tool 200 relates to law including in one embodiment, labor and employment law. The answer dialogs displayed to a user include information on the research process itself and actual data obtained while system 100 performs the research. The answer dialogs can include a series of answers that show progress in creating a plan, searching a number of vetted websites, ranking a number of search results, analyzing results for a number of research paths, and generating a final answer response.

In further applications, research using system 100 and tool 200 may be performed on tax law, data privacy law, patent law, or other areas of law involving federal and state statutes, regulations or policies, and judicial decisions. Data in storage layer 240 would then be customized for the particular area of law. For example, to configure tool 200 for tax law research, the vetted websites stored in customer database 712 would be directed to vetted tax law resources. Data in customer database 712 would likewise be directed to a tax law research application. Embeddings in vector database 812 also would be directed to a tax law research application. Configuration information to configure multi-agent layer 230 and the agents therein for tax law research can also be stored in the database 120 managed by storage layer 240. In this way, if tool 200 was to be configured for tax law research instead of labor and employment, the configuration information can be pulled from the database 120 by orchestration layer 220 so that the multi-agent operation process described herein is configured for tax law research. Further configuration information may be stored for particular customer desires or needs as well to further tune multi-agent layer 230 operation. Similar adaptations would be made to support research in other areas of law or particular customer applications as would be apparent to a person skilled in the art given this description.

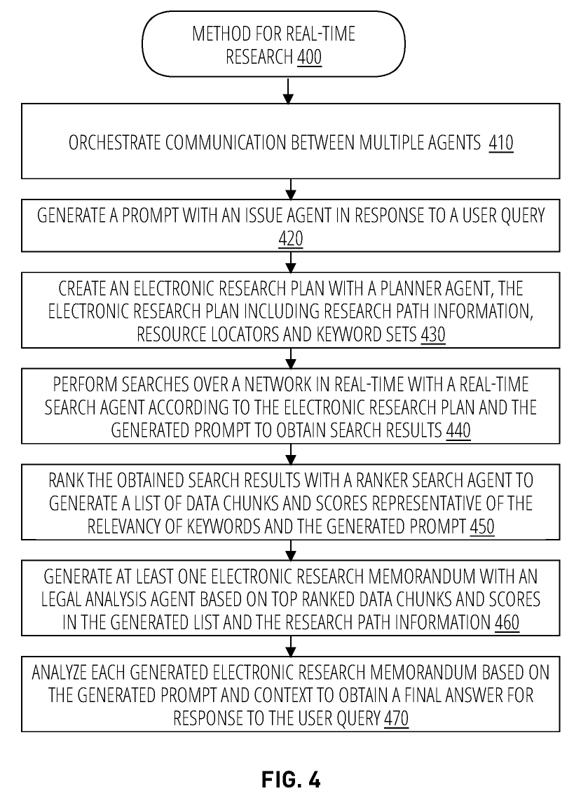

The structure and operation of system 100 including each of its components including the multiple agents is described in further detail below with respect to computer-implemented methods and examples shown in FIGS. 4-12.

FIG. 4 illustrates a computer-implemented method 400 for performing real-time research with multiple agents on an agentic AI platform in accordance with one embodiment (steps 410-470). For brevity, method 400 is described with respect to system 100 but is not necessarily intended to be limited to the embodiments of system 100. Method 400 therefore provides an explicit mapping from the structural elements of system 100, including multi-agent layer 230, orchestration layer 220, and storage layer 240, to a concrete sequence of operations in which each named agent performs a defined role under control of the orchestration layer. This mapping illustrates how the system structure is realized in a particular, ordered combination of steps rather than in an unspecified “black box” of legal research, which may facilitate targeted performance tuning at each stage. Implementing the method in this ordered fashion may also make it easier to locate and optimize performance bottlenecks in individual stages without modifying the rest of the pipeline.

In step 410, communication between multiple agents is orchestrated. For example, orchestration layer 220 may orchestrate communication to and from and between each agent in multi-agent layer 230. Orchestration layer 220 may also orchestrate communication with storage layer 240. Another step generates a final prompt with issue agent 310 in response to a user query (step 420). In step 430, an electronic research plan is created with planner agent 320. The electronic research plan includes research path information, resource locators and keyword sets. In step 440, the method performs searches over a network in real-time with real-time search agent 330 according to the electronic research plan created by planner agent 320 and the final prompt generated by issue agent 310 to obtain search results. In step 450, the method ranks the obtained search results with ranker search agent 340 to generate a list of data chunks and scores representative of the relevancy of keywords and the generated final prompt. In step 460, the method generates at least one electronic research memorandum with analysis agent 350 based on top ranked data chunks and scores in the generated list and the research path information. Finally, in step 470, the method analyzes each generated electronic research memorandum based on the generated final prompt and context to obtain a final answer for response to the user query.

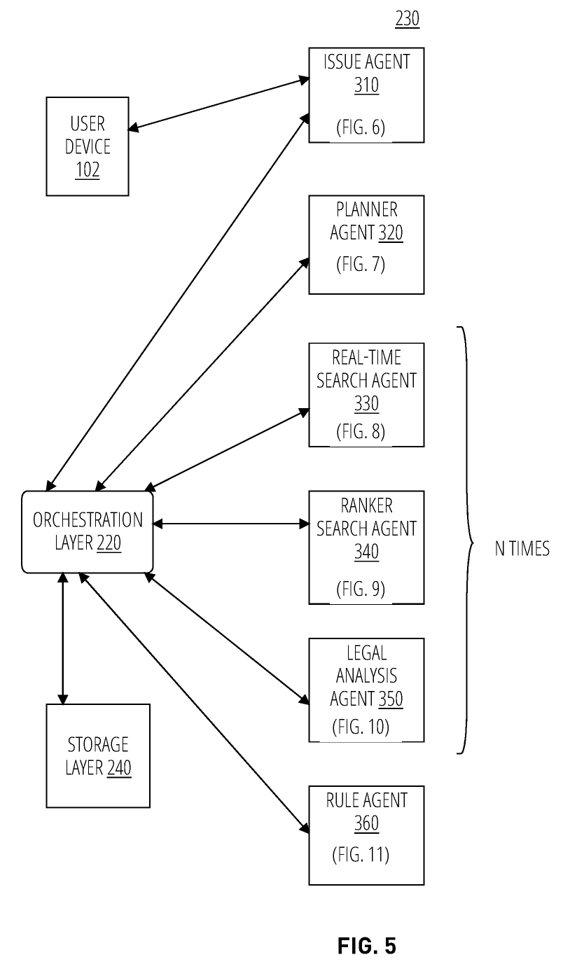

Method 400 and its steps are described in further detail below with respect to the operation of orchestration layer 220 and agents 310-360 in multi-agent layer 230 in FIGS. 5-11 and the example display views provided through a user-interface shown in FIGS. 12A-12D. For brevity, description is made with respect to research involving employment law but other areas may be researched in further embodiments.

FIG. 5 illustrates communication between layers of tool 200 in accordance with one embodiment. As shown in FIG. 5, orchestration layer 220 communicates with multi-agent layer 230 and storage layer 240. In operation, a user device 102 can send a query to issue agent 310. Issue agent 310 processes the query and returns a final prompt to orchestration layer 220. Orchestration layer 220 further communicates with each of agents 320-360 passing data to and from the agents as they operate autonomously. In one example, real-time search agent 330, ranker search agent 340 and analysis agent 350 each process input data N times (where N is an integer, such as, three) to further improve the quality of a final answer output by rule agent 360 as described further below. Further each of the agents can also communicate with storage layer 240 directly themselves or through orchestration layer 220 to receive and output data, or make API calls or other requests to database 120 and any of cloud services 130. In particular, orchestration layer 220 may maintain explicit state for each research session identifying which agents have completed their tasks, which parameter collections have been applied, and which intermediate artifacts (such as final prompt 622, output 714, output 814, and output 910) are available in storage layer 240. This explicit session state allows the system to resume or extend a research workflow without re-executing completed steps, which may reduce redundant processing and database access when users revisit or refine prior queries. Maintaining this explicit inter-layer communication may allow the system to avoid re-executing completed stages when only later stages need to be revisited, which can reduce redundant CPU and database activity.

FIG. 6 illustrates an issue identification process carried out by an issue agent 310 to generate a final prompt (step 420) in accordance with one embodiment (steps 604-612). Issue agent 310 receives a user query 602 from a user device 102. The query for example may be a natural language prompt entered by a user regarding a question or need for information. Issue agent 310 then proceeds to determine whether the query is drawn to a single issue (step 604), whether the query needs to be escalated to an attorney (step 606) and whether follow up questions need to be sent to the user (step 608).

In step 604, issue agent 310 evaluates whether the received user query 602 contains a single issue or has one or more issues. Issue agent 310 may parse and perform prompt engineering or query reformulation to assess whether the user query 602 is drawn to a single issue or can be rewritten as a single issue query. For example, a single issue may be one issue generally relating to employment and labor law. If yes, control proceeds to step 606. If no, control proceeds to step 608.

In step 606, issue agent 310 evaluates whether to escalate the processing of the user query 602 (as input or rewritten to a single issue) to an attorney. Escalation may be triggered for example if the single issue relates to categories outside the domain of system 100, such as, an issue outside a relevant jurisdiction (such as international law), an issue involving inaccessible confidential information (like a private collective bargaining agreement) or an issue outside of labor and employment law. When escalation to an attorney is triggered control then proceeds to exit and system 100 does not continue to research the particular user query.

If escalation to an attorney is not needed, control proceeds to step 608 to determine if follow up questions are needed. One or more follow up questions may be needed to further hone the scope of the user query 602 to a single issue, such as, a single issue relevant to labor and employment law. The one or more follow up questions can be sent as follow up responses to the user at the user device 102. The user can then provide additional responses to issue agent 310 to help reformulation of the query to a single issue.

Once a query is drawn to a single issue, not escalated, and no further questions are needed, control proceeds to step 610. In step 610, the user query 602 (as input or reformulated) is rewritten in an attorney persona using generative AI. Issue agent 310 then outputs a final prompt 622 representative of the rewritten user query 602.

In one implementation, issue agent 310 performs each of steps 604, 606, 608 and 610 using one or more large language models (LLM) (LLM 620). For example, in each step, issue agent 310 may make a respective API call to a cloud service 130 having a trained LLM 620. In step 604, issue agent 310 may pass the received user query 602 as a prompt to LLM 620. Further optional context can also be provided. LLM 620 then processes the received prompt and any context to determine whether user query 602 contains a single issue and returns a result to issue agent 310. Similarly, in step 606, issue agent 310 may pass the received user query 602 as a prompt to LLM 620 along with any optional context. LLM 620 then processes the received prompt and any context to determine whether user query 602 should be escalated to an attorney (step 606). If LLM 620 indicates the user query 602 does not need to be escalated, LLM 620 determines whether follow up questions are needed and generates one or more follow up questions for sending by issue agent 310 as follow up responses to the user query 602 (step 608) to obtain a new, more relevant and tailored input user query 602.

When issue agent 310 determines the user query 602 is sufficiently limited to a single issue, issue agent 310 passes the user query 602 as a prompt to LLM 620 to be rewritten by the LLM 620 in an attorney persona (step 610). LLM 620 returns the rewritten query in an attorney persona for output as a final prompt 622 by the issue agent 310 (step 612). For example, LLM 620 may process the prompt and any context to generate a final prompt 622 that represents the processed user query 602 rewritten in an attorney persona. Issue agent 310 then outputs final prompt 622 to orchestration layer 220 and/or to storage layer 240.

In another implementation, aspects of issue agent 310 functionality may be distributed between multi-agent layer 230 and user device 102 and can even be done locally on user device 102 when computation resources on user device 102 permit. For example, user device 102 may support locally stored or accessible trained ML models for performing one or more of steps 604 -610. In this way, some or all of the issue agent operations having query evaluation, query reformulation, prompt engineering or generative AI output in steps 604 -610 may be performed on user device 102. In certain embodiments, offloading steps 604-610 to capable user devices 102 when possible may reduce load on centralized servers and shorten network round-trip delays for classification and prompt-reformulation operations. Performing these preliminary computations closer to the user can improve perceived responsiveness and may reduce the aggregate CPU and network usage of the shared multi-agent service platform 110. Distributing these computations may also allow back-end resources to be reserved for the more intensive analysis and ranking stages.

The operation of issue agent 310 provides a number of advantages. By generating follow up questions and automatically reducing a query to a single issue, a user does not have to perform complex prompt engineering or query reformulation. Using generative AI to rewrite a query in an attorney persona further clarifies user input and improves the relevance and accuracy of a final answer provided by tool 200. Users also can easily perform online legal research using a chat interface.

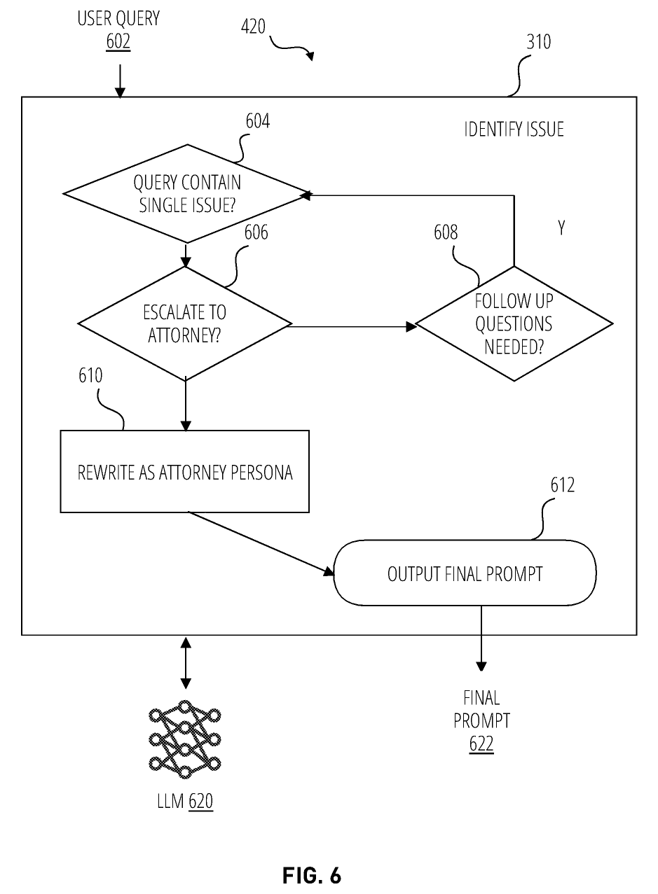

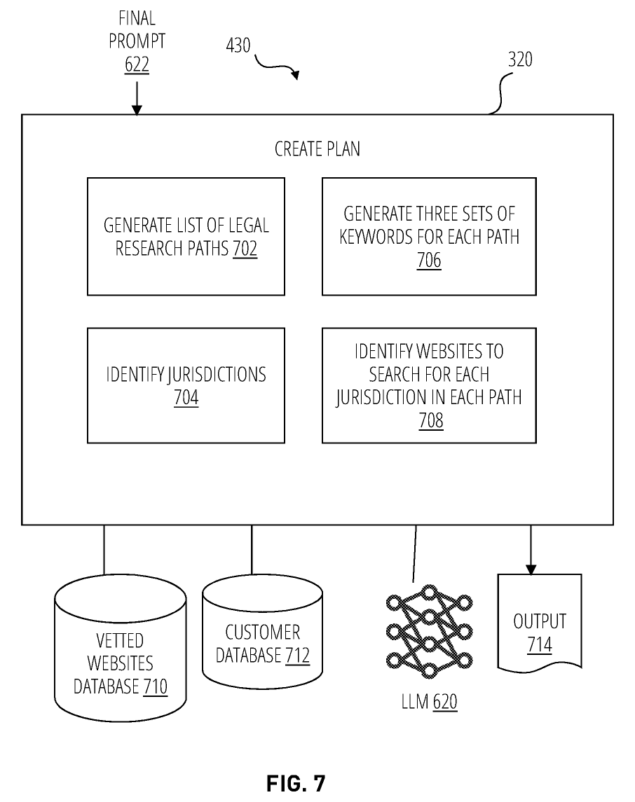

FIG. 7 illustrates electronic research plan creation (step 430) by a planner agent 320 in accordance with one embodiment (steps 702-708). Planner agent 320 receives final prompt 622. For example, planner agent 320 may obtain final prompt 622 output by issue agent 310 from orchestration layer 220 or from storage layer 240. Planner agent 320 is also coupled to a vetted websites database 710 having information on vetted websites, such as, URLs and title information, and a customer database 712 having customer information. In examples, the databases 710, 712 may be part of database 120 or accessed through a cloud service 130. Planner agent 320 may also communicate with orchestration layer 220 and/or storage layer 240 to retrieve data from the databases.

Planner agent 320 uses one or more large language models (LLM 620) to generate a list of legal research paths (step 702) and to identify jurisdictions (704) based on the final prompt 622. For example, in step 702, planner agent 320 may pass the final prompt 622 as a prompt to LLM 620. Further optional context can also be provided. LLM 620 then processes the received prompt and any context to generate a list of research paths relevant to the final prompt 622. Similarly, in step 704, planner agent 320 may pass the received final prompt 622 as a prompt to LLM 620 along with any optional context. Because planner agent 320 uses LLM 620 to generate structured artifacts such as lists of research paths, jurisdiction identifiers, and keyword sets that are then consumed programmatically by other agents, the language model is not used merely to draft narrative content but to drive the configuration of subsequent computational steps within the multi-agent pipeline. This structured use of model output enables orchestration layer 220 to treat planning results as machine-readable data rather than opaque text, which may reduce downstream parsing work. LLM 620 then processes the received prompt and any context to identify jurisdictions relevant to the final prompt 622. Because these planning artifacts are structured rather than free-form text, they can be stored and reused efficiently, which may reduce both storage overhead and repeated processing of similar queries.

Planner agent 320 also uses one or more large language models (LLM 620) to carry out steps 706 and 708. For example, in step 706, planner agent 320 may pass the final prompt 622 and list of legal research paths generated in step 702 as prompts to LLM 620. Further optional context can also be provided. LLM 620 then processes the received prompts and any context to generate three sets of keywords relevant to the final prompt 622 for each path in the generated list of research paths. In one feature, LLM 620 is provided with a prompt to generate three sets of keywords corresponding to respectively broad, moderately specific and highly specific keywords based on the final prompt 622.

Similarly, in step 708, for each jurisdiction in each legal research path, planner agent 320 identifies relevant resource locators of vetted sites in vetted websites database 710 and relevant customer data in customer database 712. To do this, planner agent 320 may use LLM 620. Planner agent 320 may send the list of legal research paths and identified jurisdictions and the final prompt 622 as prompts to LLM 620 along with any optional context. LLM 620 then processes the received prompt and any context to identify the relevant resource locators for each jurisdiction in each legal research path. Planner agent 320 may then generate output 714 having data identifying each of the legal research paths for a set N of paths (where N is an integer), and each path having a list of resource locators (e.g., URLs) and keyword sets (such as, the three sets of keywords corresponding to different degrees of specificity). Planner agent 320 may provide output 714 to orchestration layer 220 and/or to storage layer 240.

In one embodiment, vetted websites database 710 has a curated list of vetted websites. In one example, there are 460 or more URLs stored in vetted websites database 710 that address websites having relevant state and federal information on labor and employment law. Customer database 712 may be a database hosted on a cloud service and accessible for search (such as, a database accessible by a Microsoft Azure search.). In one implementation, customer database 712 may include indexed and/or vectorized data to facilitate real-time search. For example, customer database 712 may include data for manuals in all 50 states of the United States.

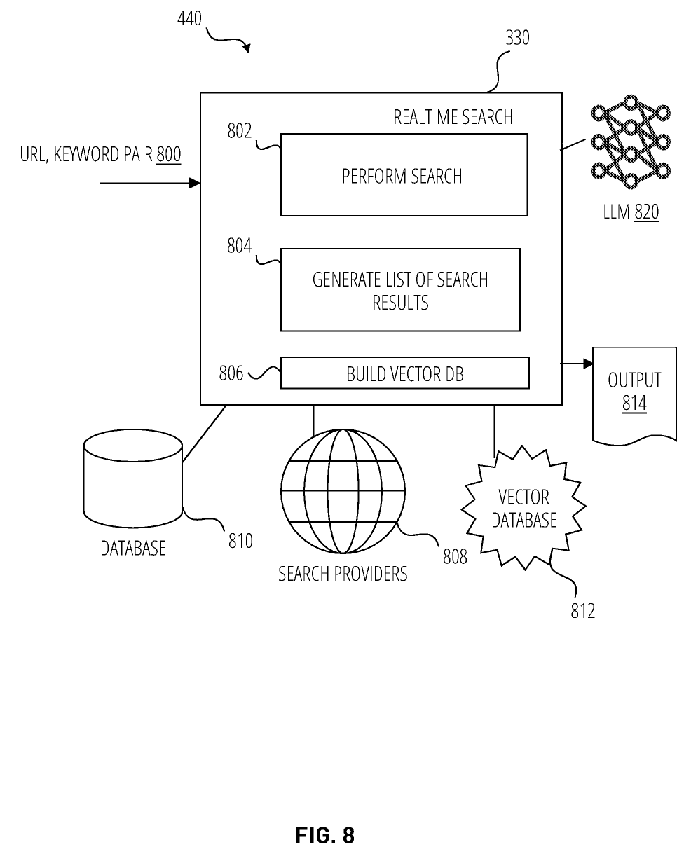

FIG. 8 illustrates real-time search operation (step 440) by real-time search agent 330 in accordance with one embodiment (steps 804-808). Real-time search agent 330 receives input data having a URL, keyword pair 800. In step 802, for each pair of resource locators and sets of keywords output by the planner agent 320, real-time search agent 330 performs searches over network 108 in real-time at resources identified by the URLs using the sets of keyword pairs. Real-time search agent 330 obtains search results from these searches and generates a list of the search results (step 804) as data in output 814. By organizing the real-time search stage as a distinct agent that receives structured path and keyword information from planner agent 320 and returns normalized search results to ranker search agent 340, the system constrains network querying to a controlled phase of the multi-agent workflow and avoids embedding arbitrary search logic within downstream analysis steps, which may simplify implementation and reduce duplicated networking code. Confining network activity to this stage of the workflow may simplify monitoring of external calls and may help ensure that bandwidth usage remains bounded as the number of research paths grows.

For even more flexibility, input data may also include a resource locator that identifies a resource in a database 810 (such as a public or proprietary database such as a Microsoft Azure database accessed through a cloud service 130 or as part of database 120). Real-time search agent 330 may also perform a real-time search of database 810 using the sets of keyword pairs and further add these database search results to output 814. Treating database 810 search results as another source of context alongside web results allows real-time search agent 330 to interleave proprietary and public data without changing its downstream interface, which may simplify the design of ranker search agent 340 and analysis agent 350. This uniform treatment of heterogeneous sources may reduce code duplication and may streamline maintenance of the overall research pipeline. Handling these results through a common interface may also reduce the amount of custom parsing logic that must be executed for each source type.

In a further alternative implementation, real-time search agent 330 is also coupled to a vector database 812. An embeddings model (LLM 820) may be included and coupled to vector database 812 to support further queries to obtain search results for output 814.

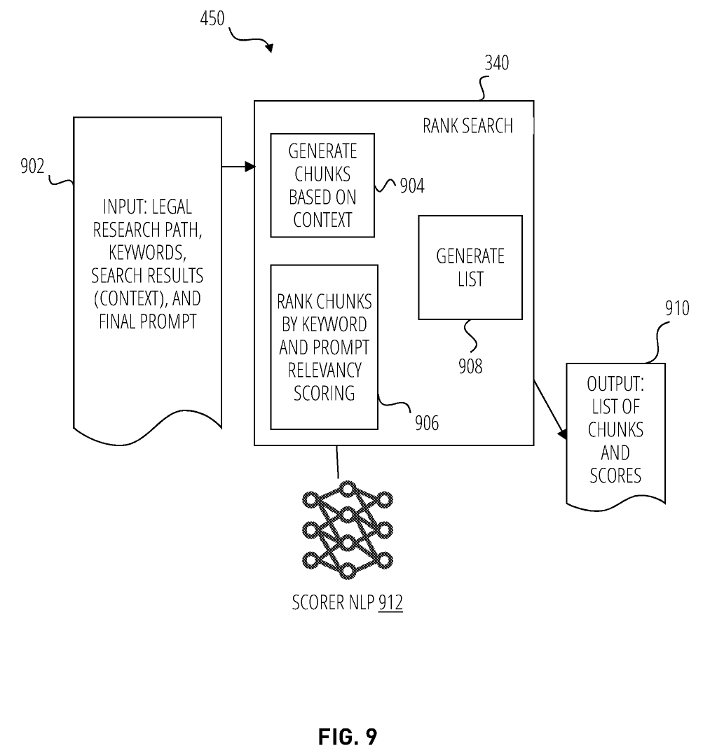

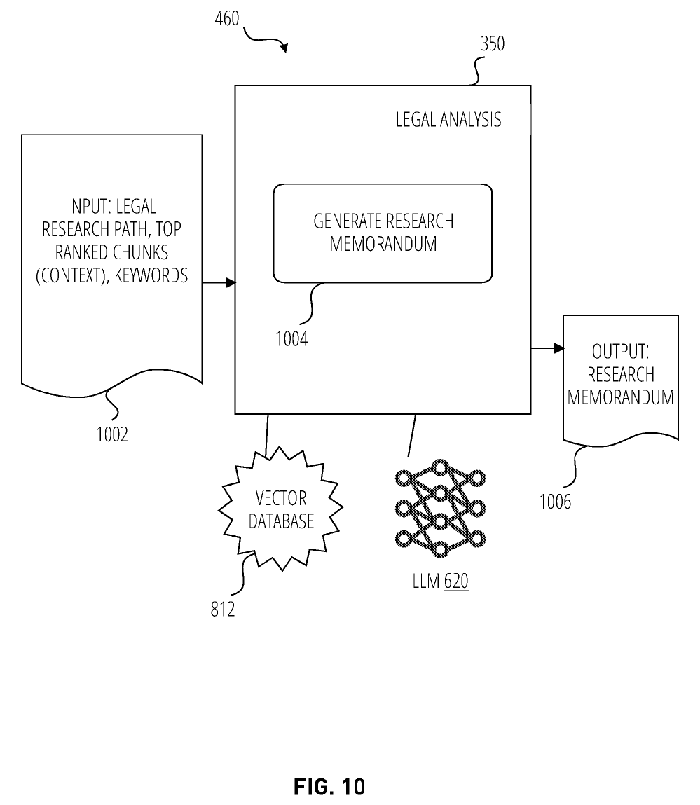

FIG. 9 illustrates ranked search operation (step 450) by a ranker search agent 340 in accordance with one embodiment (steps 904-908). Ranker search agent 340 may receive input 902 that includes data on legal research paths, associated keywords, search results (context), and final prompt 622. In step 904, ranker search agent 340 generates chunks of data based on context (the search results). In step 906, ranker search agent 340 ranks the chunks by scoring the relevancy of the chunk against search keywords and the final prompt 622. In step 908, ranker search agent 340 generates a list of the chunks and scores. Ranker search agent 340 outputs an output 910 having the generated list of chunks and scores. In particular, ranker search agent 340 may assign scores using both the search keywords and final prompt 622 so that the resulting list captures not only keyword overlap but also alignment with the issue framing produced by issue agent 310. This coordination between the outputs of issue agent 310, planner agent 320, and ranker search agent 340 reflects a specific information flow within multi-agent layer 230, in contrast to systems that apply ranking in isolation from prompt reformulation and path planning. This separation of ranking from later analysis may allow the system to reserve more expensive computational resources for a smaller subset of high-value chunks, which can improve end-to-end efficiency.

In one example, a chunk is a snippet of content (512 words). Scores for the chunks are determined using a trained machine learning model (scorer NLP 912). In certain embodiments, the chunk size of approximately 512 words may be selected to balance semantic completeness against memory and bandwidth costs, so that each chunk is large enough to capture legally meaningful context but small enough to avoid excessive duplication and to fit within typical model context windows without fragmentation. This balance may reduce redundant text transmission between agents and may improve the ratio of useful content to tokens processed by downstream models. For each chunk, scorer NLP 912 predicts scores indicative of the relevance of the information in the chunk to the research against associated keywords and the final prompt 622 generated by issue agent 310, as well as relevance to the specific research path generated by planner agent 320. In some embodiments, the scores predicted by scorer NLP 912 are stored together with identifiers of the corresponding chunks in storage layer 240, so that subsequent agents can retrieve only those chunks whose scores exceed a threshold or fall within a top-K set for each research path. This use of stored scores as a filter allows the claimed storage layer to participate directly in constraining later processing, rather than acting as passive storage for unstructured search results, which may reduce disk I/O and memory usage for downstream agents. Limiting downstream processing in this way may reduce the volume of data that later agents must load into memory and evaluate, which can improve overall throughput on the deployed servers.

To carry out step 906, ranker search agent 340 may use scorer NLP 912. For example, scorer NLP 912 may use natural language processing (NLP) techniques incorporating BM25 scoring. By storing the BM25 model as a compact tokenized index, some embodiments may perform relevance ranking using only integer or fixed-point operations on relatively small in-memory structures, which can be more cache-friendly than repeatedly invoking large neural models for every candidate document. This design may improve ranking throughput, reduce main-memory bandwidth usage, and may lower overall energy per ranked result compared to purely neural ranking pipelines. An indexer uses a function to rank the chunks against final prompt 622 and a particular research path. The function may build a BM25 model which may be stored in memory as a tokenized list. This list may later be called by a function that retrieves the top N documents most responsive to either final prompt 622 or a particular research path. Using this index-based approach to ranking may reduce reliance on repeated large-model inference for every document and may therefore lower both memory traffic and compute load during the ranking stage.

In an alternative embodiment, inline vectorization can be used to transform search results into vector embeddings in real-time. These embeddings may be stored in a database. An embeddings LLM may be used instead of scorer NLP 912 enabling efficient retrieval of relevant information.

In some embodiments, a controller within ranker search agent 340 may select between BM25-based scoring and inline vectorization based on current system constraints, such as embedding model throughput, token limits, or available accelerator capacity. For example, when embedding models are rate-limited or token budgets are tight, the controller may favor BM25 scoring on pre-indexed text; when additional compute resources are available, the controller may enable vectorization to improve semantic recall. This adaptive scoring strategy may allow the system to operate within resource limits while maintaining acceptable ranking quality across varying load conditions, which may support more predictable hardware usage. Choosing between these scoring strategies at runtime may thus avoid overloading particular compute resources while still delivering useful rankings.

FIG. 10 illustrates legal analysis operation (460) performed by analysis agent 350 in accordance with one embodiment (step 1004). Analysis agent 350 may receive input data 1002 having legal research paths, top ranked chunks (context) and keywords. Analysis agent 350 generates a research memorandum for each legal research path (step 1004). For example, analysis agent 350 may call LLM 620 to generate research memoranda. Analysis agent 350 may send top ranked chunks of data and keywords for each path as prompts and context for LLM 620. LLM 620 then processes the received prompts and context and generates research memoranda including a set of memoranda covering each respective legal path and corresponding to the top-ranked chunks and keywords. Analysis agent 350 then outputs the generated research memorandum as output 1006.

In another alternative embodiment, an LLM may query vector database 812 to retrieve information relevant to a research path and generate research memoranda as output 1006.

In further embodiments, when analysis agent 350 or an LLM queries vector database 812, the system may limit retrieval to the top K embeddings per research path, where K is selected to bound downstream processing costs while maintaining adequate coverage of relevant authority. This controlled retrieval size may reduce the volume of context passed into subsequent LLM calls and may therefore limit token usage, memory consumption, and compute time per memorandum. By bounding the number of retrieved items, the system may keep per-request memory usage and processing time within predictable limits.

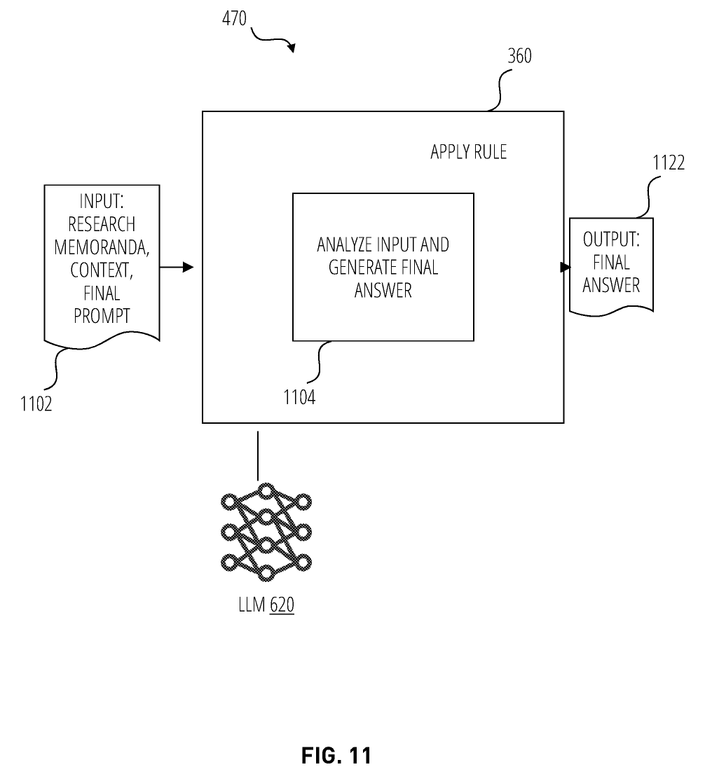

FIG. 11 illustrates rule application (step 470) by a rule agent 360 in accordance with one embodiment. Rule agent 360 may receive input 1102 having input data that includes research memorandum generated by analysis agent 350, context and final prompt 622. Rule agent 360 may provide the input 1102 to one or more large language models (LLM 620) to analyze and generate a final answer (step 1104). Rule agent 360 provides output 1122 that includes the final answer generated by LLM 620. Rule agent 360 may provide output 1122 to orchestration layer 220 and/or to storage layer 240 for subsequent output and display at user device 102 to fulfill user query 602.

FIGS. 12A to 12E illustrate example user-interface display panels having content produced during real-time research in accordance with one embodiment. In FIG. 12A, a display panel 1202 includes a viewable display area for showing a chat carried out between user device 102 and tool 200. As shown in FIG. 12A, a chat may have a welcome message followed by an example query 1208, follow up question 1210 and response 1212. Query 1208 may be a question a user enters to ask of tool 200 which is received and processed by issue agent 310 as described earlier. Follow up question 1210 is a follow up question generated by issue agent 310 as described above with respect to step 608. Response 1212 is a response to the follow up questions 1210 input by a user. Controls may also be provided in the user-interface panel display panel 1202 to enable to user to generate new chat, logout, or view chat session history. Scroll bars, jump buttons, or other graphical user-interface aids may be provided to enable a user to scroll or navigate a chat.

FIG. 12B shows a display panel 1204 that may be displayed to show a final answer 1214 provided in response to the user query of FIG. 12A. The final answer 1214 is generated by rule agent 360 and output by tool 200 as described above with respect to FIG. 11. As shown in FIG. 12B, the final answer 1214 may be included as part of the same chat with the original query 1208, follow up question 1210, and response 1212 provided earlier during the research. A final answer may often be structured with headings, text and formatting as shown, and may require scrolling to view in its entirety depending on length.

FIG. 12C shows a respective display panel 1206 having additional parts of the final answer 1214. FIG. 12D shows more additional parts that may be included with a final answer 1214. The additional parts include sections having a conclusion, references, supporting research, summary information, and legal research paths information. In this way, a user can continue to review the answer and supporting material.

FIG. 12E shows an answer dialog 1216 that may be generated and displayed on user device 102 in accordance with a further feature. Answer dialog 1216 includes descriptions of the progress of the legal research at different stages (creating a plan, real-time search, ranking search results, analyzing research paths, and generating a response). In a further feature, answer dialog 1216 also includes performance data indicative of the activity carried out at different stages including the number of resources searched (such as, the number of web sites searched), number of web search results ranked, and number of research paths being analyzed. Tool 200 then uses the performance data to generate answer dialogs.

In one embodiment, orchestration layer 220 includes a data tracker that tracks and stores the performance data. For example, data from the agents in multi-agent layer 230 may be logged during the execution of the respective agent to database 120. The data tracker may poll the underlying performance data for changes every three seconds and include the changes in the answer dialog.

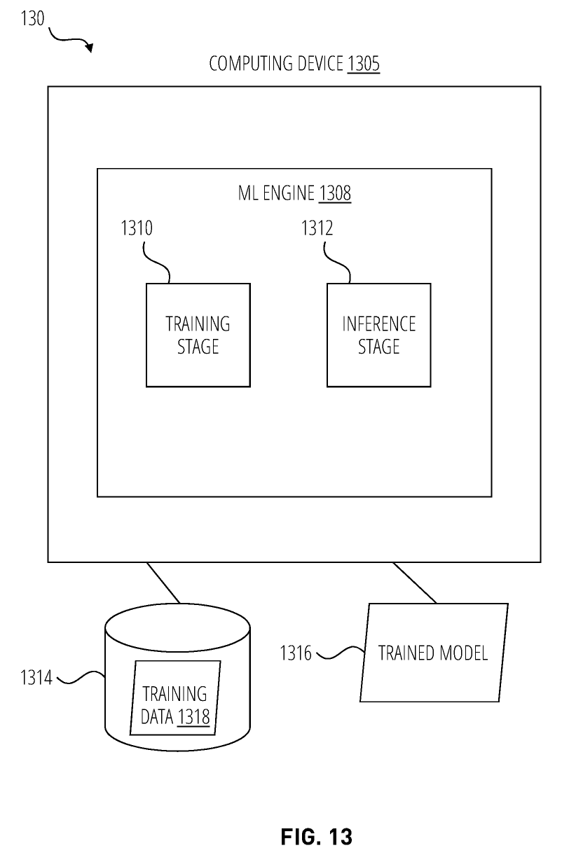

FIG. 13 illustrates an example cloud service 130 that can be used to perform machine learning (ML) in accordance with one embodiment. In one embodiment, cloud service 130 may include an Azure AI service with machine learning provided by Microsoft Inc.

In one embodiment, cloud service 130 includes an ML Engine 1308 implemented on computing device computing device 1305. Computing device 1305 includes one or more processors and computer-readable memory. ML Engine 1308 includes a training stage 1310 and an inference stage 1312. Training stage 1310 evaluates training data 1318 with a machine learning model to generate a trained model 1316. Inference stage 1312 applies the trained model 1316 to input data to obtain a predictive or generative output. For example, trained model 1316 may be any of LLM 620, LLM 820 or scorer NLP 912. This separation between training and inference may help ensure that heavy retraining jobs do not degrade the responsiveness of live research sessions.

In certain embodiments, training stage 1310 may also be used to periodically retrain scorer NLP 912 or embeddings models on updated corpora of legal documents, while inference stage 1312 continues to serve live research traffic using a prior version of the models, thereby decoupling training workloads from production query handling. This separation may avoid contention for compute and memory resources between training and inference, which can preserve low-latency behavior for users during retraining cycles.

In one embodiment, LLM 620, LLMs 820 may be any type of trained model that can perform natural language processing. This may include one or more large language models and can include an attention or transformer mechanism. For example, LLM 620 may be a large language model, such as, one or more LLM models used in the Azure AI service available from Microsoft Inc., ChatGPT provided by OpenAI (such as model GPT-4o), Gemini available from Google Inc., Claude available from Anthropic, or other ML service provider.

In one embodiment, system 10 utilizes a large language model LLM 620, LLM 820, or any variation thereof within an agentic flow, optimized through the selection of a corresponding set of tuned parameters retrieved from storage layer 240. In this embodiment, each task performed by an agent in multi-agent layer 230 is optimized for its specific purpose by retrieving directives that include a specific model selection, a customized prompt, and various configuration parameters. For example, a first parameter collection for issue agent 310 may specify a relatively small context window and conservative sampling parameters to ensure rapid classification and prompt generation, while a second parameter collection for analysis agent 350 may specify a larger context window and different decoding settings to support deeper analysis of top-ranked chunks. By tailoring these collections to the functional role of each agent, some embodiments consolidate processing effort at stages where it is most beneficial and avoid expending large-model resources at preliminary steps, which may shorten end-to-end latency and reduce unnecessary accelerator or CPU usage. This combination of model selection, prompt tuning, and parameter configuration helps optimize a desired output and with better performance than attainable through the use of conventional off-the-shelf models alone. The parameter collections function analogously to meticulously written and optimized software code tailored to specific hardware, ensuring that the performance of tool 200 is uniquely optimized for each task.

In operation, when an agent such as issue agent 310 or analysis agent 350 invokes an underlying language model, the directives contained in the retrieved parameter collection may be applied before the model is called, so that prompt content, context window size, decoding parameters, and model identity are all determined by the stored configuration instead of being recomputed or left to ad hoc selection logic at runtime. This use of stored parameter collections to govern model behavior provides a specific implementation of model configuration that can be adjusted by modifying the collections in storage layer 240 without altering code paths in the agents themselves, which may simplify updates and reduce deployment risk. As a result, tool 200 may achieve more efficient use of processor and memory resources when executing repeated tasks across matters, because model behavior is controlled by compact records stored in storage layer 240 rather than by recalculating parameters for each request.

In a further feature, configuration information is stored for tuning multi-agent operation for a particular area of law, customer design preference, or other application. In one embodiment, storage layer 240 is configured to store configuration information for configuring agents in the multi-agent layer 230 to optimize performance of research for a particular area of law. In some embodiments, the configuration information is selected so that, for a given area of law, the same set of tuned parameters is consistently applied whenever agents in multi agent layer 230 perform research for that area of law, thereby causing the system to respond in a repeatable manner for similar queries and matters. This consistent tuning of model selection, prompts, and configuration parameters for each domain may improve stability and accuracy of results and may avoid unnecessary reconfiguration logic that would otherwise consume processing cycles and power supply at runtime. The orchestration layer 220 is configured to retrieve the configuration information associated with a particular area of law to tune the agents in multi-agent layer 230 for performing research in the particular area of law. In certain embodiments, tuning the agents in this manner causes orchestration layer 220 to route tasks for the same user query through different agents with different parameter collections, so that preliminary classification, retrieval, ranking, and analysis are each carried out under parameters tailored to the functional role of the respective agent rather than under a single global configuration. This task-specific tuning may keep each agent’s working set closer to what its underlying hardware or model can process efficiently, reducing wasted compute. Tool 200 may also have configuration information that includes a plurality of parameter collections. Each parameter collection has a specific model selection, a customized prompt, and a set of configuration parameters. Orchestration layer 220 is configured to retrieve a parameter collection from storage layer 240 for each task performed by an agent in multi-agent layer 230. The retrieved parameter collection is applied to optimize the performance of tasks carried out each agent in multi-agent layer 230. Because orchestration layer 220 may retrieve a parameter collection for each task performed by an agent in multi-agent layer 230 and apply the retrieved parameter collection to that task, the same underlying models may be reused in different ways across tasks and legal domains without re-training or hard-coding separate models. This arrangement provides a concrete mechanism by which the system changes the behavior of the AI components as a function of task type and legal area, rather than merely invoking a generic model uniformly, and may reduce storage requirements by avoiding duplication of model binaries for each use case. In one embodiment, the real-time research may relate to at least one of labor and employment law or tax law, and the plurality of parameter collections include respective parameter collections associated with research in labor and employment law or tax law. A user-interface panel may include a user-interface element, such as, a checkbox, button, pulldown menu or other control, to allow a user to select an area of law for research. Tool 200 in response notifies orchestration layer 220 to retrieve the parameter collection associated with the area of law selected by the user. Other technical features may be readily apparent to one skilled in the art from the following figures, descriptions, and claims.

In certain embodiments, parameter collections for different areas of law may be organized as compact records with pre-tokenized prompts and pre-computed model routing decisions, enabling orchestration layer 220 to select and apply a parameter collection using a single lookup and without re-parsing large prompt templates at runtime. By reducing per-task parsing and configuration logic, such embodiments may streamline request handling, lower CPU utilization for orchestration, and permit a higher volume of concurrent research sessions on the same server infrastructure. These configuration driven adjustments may reduce the amount of per request computation needed to set up agent calls and may help keep response latency predictable across different legal domains on a shared hardware platform.

### Further Computer-Implemented Embodiments

Multi-agent service platform 110, tool 200 and layers 210 - 250 including the agents 310 - 360 in multi-agent layer 230, may be implemented on a cloud computing platform, such as, Azure or AutoGen available from Microsoft Inc. Multi-agent service platform 110 may be implemented on one or more servers. The servers include one or more processors and can be distributed at the same or different locations. Web servers may also be included and coupled to servers of multi-agent service platform 110 to support operations and enable communications (through Web protocols and networking layers) between platform 110 and browsers on remote user devices 102.

Further examples of cloud computing that may be used to implement multi-agent service platform 110 are distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), application programming interface as a service (APIaaS), or an integration platform as a service (IPaaS).

User devices 102 and computing device 1305 can be any type of computing device including, but not limited to, a smartphone, laptop, desktop, tablet, workstation, kiosk or other computing device having at least one processor and a non-transitory computable readable memory. User devices 102 and computing device 1305 may include a browser, application, and operating system along with a user-interface depending upon a desired configuration. ML engine 1300 may also be implemented on computing device 1305 or other remote computing devices at the same or different locations. In further embodiments, user devices 102 and computing device 1305 may cache recent configuration information, vetted resource locators, or frequently used research paths in local memory so that repeated queries in the same matter reuse previously retrieved data instead of issuing new network requests. This local caching may reduce round trip network calls to multi agent service platform 110, shorten perceived response time for the user, and may reduce overall power draw on network interfaces and remote servers by cutting down on redundant I/O. Reducing redundant remote lookups in this way may extend battery life on mobile devices and lower aggregate bandwidth usage.

Computing functionality as described herein may also be implemented on a server, cluster of servers, web server, cloud-computing platform and/or other remote service. A client/server architecture may also be implemented as would be apparent to a person skill in the art given this description. In some embodiments, the client/server architecture may place the orchestration layer and storage layer on physically co-located servers or within the same availability zone to limit cross-region traffic when agents access configuration information and search results. Such placement may curb interconnect load, reduce wide-area network latency, and may lower energy consumption associated with repeated remote data transfers during multi-stage research workflows. Locating these components close together in the network may thus help maintain consistent response times as overall traffic increases.

In a further embodiment, a computer-implemented system for real-time research with multiple agents on an agentic AI platform, includes: means for orchestrating communication between multiple agents; means for operating multiple agents autonomously from one another in an agentic AI design; and means for managing data retrieval and storage of data including data representative of vetted lists of websites or resources relating to a particular area of law for real-time searches.

In certain embodiments, the means for orchestrating communication between multiple agents may be implemented as a message routing subsystem that maintains explicit message queues per agent and enforces ordering constraints between dependent tasks so that outputs from earlier agents are consumed in a deterministic sequence by later agents. By structuring inter agent communication as queued, typed messages rather than as-necessary procedure calls, some embodiments improve data locality within the orchestration layer and may reduce synchronization overhead when coordinating concurrent agent execution, which can lower processor utilization during peak loads. This type of message-based orchestration may also make it easier to scale the number of agents across multiple processors or machines without significantly increasing coordination cost.

Information regarding multi-agent, real-time research execution and systems for performing the same are provided herein. It should be understood that any operation (e.g., a mathematical operation, agentic operation) described with respect to the present disclosure is merely illustrative of processor operations performed by a computer system configured or otherwise arranged to efficiently carry out the methods provided herein. Any operations described are not intended to capture the totality of the methods, but instead to convey qualities of computational procedures to persons having ordinary skill in the art. Procedures provided herein may be implemented on hardware and firmware configured to implement embodiments of these operations in a manner that improves the functionality of the hardware and firmware with respect to such procedures (for example, by coordinating agent execution to reduce redundant model calls, by structuring data exchanges to improve cache locality, or by routing configuration lookups to reduce memory and I/O pressure). In other words, while the methods provided herein may involve embodiments of certain operations, they should not be understood to be limited to a total performance of those operations. Further, it should be understood that any operation provided herein may be illustrative of processing associated with any of FIGS. 1-13. Systems and methods provided herein, including all described multi-agent workflows, may be implemented as deterministic, machine-executable processes and should not be construed as manual procedures, in whole or in part, for purposes of this disclosure. Moreover, these systems and methods are directed to the design and operation of optimized data processing and network research pipelines, and are not directed to legal interactions or other business practices as such, but instead to specific ways in which computing resources are organized and used to carry out said pipelines.

In some embodiments, the systems described herein for multi-agent research processing may be deployed on a cluster of interconnected servers, each equipped with one or more high-speed processors. High-speed processors may include any of CPUs, GPUs, or other accelerators suitable for parallel execution of language-model inference, ranking, and orchestration tasks. Parallelization may be useful in this context because it allows different agents, or different research sessions, to be assigned to separate processor cores or nodes, thereby reducing per-request processing time and enhancing throughput. Additionally, these dedicated computer systems for multi-agent research tasks may include substantial memory to store active configuration information, intermediate artifacts, and recent session data without bottlenecks. High-speed storage solutions, such as solid-state drives (SSDs) or high-performance network-attached storage (NAS), may be used for quick access to parameter collections, vetted resource lists, and cached search results. In some cases, the network infrastructure may support high bandwidth and low latency to facilitate rapid data transfer between orchestration servers, storage backends, and external cloud services used for model inference.

In at least one embodiment, the systems described herein are configured or otherwise arranged to construct and maintain complex data structures that approximate and manage multi-agent workflow state and context. For example, storage layer 240 and orchestration layer 220 may cooperate to maintain session records that reference final prompts, research plans, ranked chunk lists, memoranda, and performance metrics. Arrays or matrices may store scores and rankings for chunks across multiple research paths, while key-value mappings may associate session identifiers with the parameter collections applied during a given run. Additionally, graph- or tree-based structures may model and traverse dependencies between agent outputs and research steps, enabling orchestration layer 220 to determine which agents must be re-invoked when a user provides new information or when configuration is updated, without restarting the entire pipeline.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,”, “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system for providing real-time research in response to a user query, comprising:
a multi-agent service platform, implemented on at least one processor and configured to communicate with one or more user devices over a network; and
a database coupled to the multi-agent platform,
wherein the multi-agent service platform includes:
a multi-agent layer having an issue agent, planner agent, real-time search agent, ranker search agent, legal analysis agent and rule agent;
an orchestration layer configured to orchestrate communication between the issue agent, planner agent, real-time search agent, ranker search agent, legal analysis agent and rule agent; and
a storage layer configured to manage data retrieval and storage to and from the database.

2. The system of claim 1, wherein:
the issue agent generates a prompt in response to a user query;
the planner agent creates an electronic research plan, the electronic research plan including research path information, resource locators and keyword sets;
the real-time search agent performs searches over the network in real-time with a real-time search agent according to the electronic research plan and the generated prompt to obtain search results;
the ranker search agent ranks the obtained search results with a ranker search agent to generate a list of data chunks and scores representative of the relevancy of keywords and the generated prompt;
the legal analysis agent generates at least one electronic research memorandum with an legal analysis agent based on top ranked data chunks and scores in the generated list and the research path information; and
the rule agent analyzes each generated electronic research memorandum based on the generated prompt and context to obtain a final answer for response to the user query.

3. The system of claim 2, wherein the issue agent further generates one or more follow up questions for the user, assesses whether the query and users responses to follow up questions contain more than one issue, and rewrites output in an attorney persona.

4. The system of claim 2, wherein the planner agent further generates a list of legal research paths and identifies jurisdictions based on the prompt from the issue agent.

5. The system of claim 4, wherein the planner agent, for each legal research path generates a number of sets of keyword and for each jurisdiction in each legal research path identifies resource locators of vetted sites to search.

6. The system of claim 5, wherein the real-time search agent receives pairs of resource locators and sets of keywords output by the planner agent and performs the searches over the network in real-time based on the received pairs of resource locators and sets of keywords to obtain the search results.

7. The system of claim 6, wherein the ranker search agent receives the legal research paths, associated keywords and search results, and the prompt, generates a list of data chunks from the obtained search results, and ranks the chunks by scoring the relevancy of the chunk against search keywords and the generated prompt.

8. The system of claim 7, wherein the rule agent receives a set of research memorandum output by the legal analysis agent, context and the generated prompt, and analyzes each generated electronic research memorandum in the set based on the generated prompt and context to obtain a final answer for response to the user query.

9. The system of claim 1, further comprising an input layer and an output layer.

10. The system of claim 9, wherein the input layer and the output layer each communicate with a web application at a respective user device, such that a user interface panel is provided to enable a user to enter queries and follow up responses, and to view questions, answer dialogs and the final answer output by the output layer.

11. The system of claim 10, wherein the real-time research relates to labor and employment law, and wherein the answer dialogs includes a series of answers that show progress in creating a plan, search a number of vetted websites, ranking a number of search results, analyzing results for a number of research paths, and generating a final answer response.

12. The system of claim 1, wherein the real-time research relates to labor and employment law.

13. The system of claim 1, wherein the multi-agent service platform comprises an agentic AI platform and each agent in the multi-agent layer acts autonomously in response to respective communication with the orchestration layer.

14. The system of claim 13, wherein the storage layer is configured to store configuration information for configuring agents in the multi-agent layer to optimize performance of research for a particular area of law, and wherein the orchestration layer is configured to retrieve the configuration information associated with a particular area of law to tune the agents in the multi-agent layer for performing research in the particular area of law.

15. The system of claim 14, wherein the configuration information includes a plurality of parameter collections, each parameter collection having a specific model selection, a customized prompt, and a set of configuration parameters; and
wherein the orchestration layer is configured to retrieve a parameter collection from the storage layer for each task performed by an agent in the multi-agent layer, and
wherein the retrieved parameter collection is applied to optimize the performance of tasks carried out each agent in the multi-agent layer.

16. The system of claim 15, wherein the real-time research relates to at least one of labor and employment law or tax law, and the plurality of parameter collections include respective parameter collections associated with research in labor and employment law or tax law.

17. A computer-implemented method for real-time research with multiple agents on an agentic AI platform, comprising:
orchestrating communication between an issue agent, planner agent, real-time search agent, ranker search agent, legal analysis agent and rule agent implemented on at least one processor;
generating a prompt with an issue agent in response to a user query;
creating an electronic research plan with a planner agent, the electronic research plan including research path information, resource locators and keyword sets;
performing searches over a network in real-time with a real-time search agent according to the electronic research plan and the generated prompt to obtain search results;
ranking the obtained search results with a ranker search agent to generate a list of data chunks and scores representative of the relevancy of keywords and the generated prompt;
generating at least one electronic research memorandum with an legal analysis agent based on top ranked data chunks and scores in the generated list and the research path information; and
analyzing each generated electronic research memorandum based on the generated prompt and context to obtain a final answer for response to the user query.

18. The computer-implemented method of claim 17, further comprising:
storing configuration information for configuring the issue agent, planner agent, real-time search agent, ranker search agent, legal analysis agent and rule agent to optimize performance of research for a particular area of law, and
retrieving the configuration information associated with a particular area of law to tune the issue agent, planner agent, real-time search agent, ranker search agent, legal analysis agent and rule agent.

19. A system for real-time research of law, comprising:
a tool implemented on at least one processor and configured to communicate with one or more user devices over a network;
wherein the tool includes:
a multi-agent layer having an autonomous issue agent, planner agent, real-time search agent, ranker search agent, legal analysis agent and rule agent;
an orchestration layer configured to orchestrate communication between the issue agent, planner agent, real-time search agent, ranker search agent, legal analysis agent and rule agent; and
a storage layer configured to manage data retrieval and storage including data representative of vetted lists of websites or resources relating to law for real-time searches.

20. The system for real-time research of claim 19, wherein the tool is configured to perform API calls with one or more cloud services to support or perform functionality carried out by any one or more of the autonomous issue agent, planner agent, real-time search agent, ranker search agent, legal analysis agent and rule agent.

21. The system for real-time research of claim 20, wherein the issue agent, planner agent, real-time search agent, legal analysis agent and rule agent are each coupled to a large language model configured to perform natural language processing according to a trained model and wherein the ranker search agent is coupled to a large language model configured to perform natural language processing according to a trained model and to perform scoring.

22. The system for real-time research of claim 19, wherein the storage layer is configured to store configuration information for configuring the issue agent, planner agent, real-time search agent, ranker search agent, legal analysis agent and rule agent to optimize performance of research for a particular area of law, and wherein the orchestration layer is configured to retrieve the configuration information associated with a particular area of law to tune the issue agent, planner agent, real-time search agent, ranker search agent, legal analysis agent and rule agent.

23. The system for real-time research of claim 21, wherein the orchestration layer retrieves the configuration information associated with the particular area of law in response to a user selecting the particular area of law for research at a user device coupled to the tool over the network.

24. The system for real-time research of claim 22, wherein the particular area of law is labor and employment law or tax law.

25. A system for real-time research of law, comprising:
a tool implemented on at least one processor and configured to communicate with one or more user devices over a network;
wherein the tool includes:
a multi-agent layer having multiple agents configured to operate autonomously from one another in an agentic AI design;
an orchestration layer configured to orchestrate communication with the agents; and
a storage layer configured to manage data retrieval and storage to and from a database including data representative of vetted lists of websites or resources relating to a particular area of law for real-time searches.

26. The system for real-time research of claim 24, wherein the multiple agents include an issue agent, planner agent, real-time search agent, ranker search agent, legal analysis agent and rule agent.
